(19) United States
(12) Patent Application Publication
(10) Pub. No.: US 2012/0251815 A1
(43) Pub. Date: Oct. 4, 2012

(54) USE OF FOAMING AGENTS IN THERMOPLASTIC CONSTRUCTION MEMBRANES

(76) Inventor: Harvey Howells, Spartanburg, SC (US)

(21) Appl. No.: 13/244,521

(22) Filed: Sep. 25, 2011

Related U.S. Application Data
(60) Provisional application No. 61/404,016, filed on Sep. 27, 2010.

(51) Int. Cl. B32B 3/26

(52) U.S. Cl. 428/316.6

(57) ABSTRACT

Roofing, waterproofing, geomembranes or other construction membranes are made by foaming agents to individual layers of TPO, PE, PP, EVA, other olefinics or PVC, etc. This new membrane offers lower weight, lower modulus, LEED certification, improved fire test performance, improved R value and sound deadening.

### PRIORITY

The present application claims priority under 35 USC section 119 and based upon a provisional application filed in Sep. 27, 2010 with a Ser. No. 61/404,016.

### FIELD OF THE INVENTION

The present invention relates to thermoplastic roofing, both specialty and commercial, and geomembranes and more particularly to roofing that provides lower weight, lower modulus, improved insulating qualities, sound deadening, improved fire test performance and LEED certification capability.

### BACKGROUND

The majority of thermoplastic roofing and geomembranes are made from olefinics, primarily TPO, PP, or PE. Some are also produced using PVC, thermoplastic nitrile or isobutylene.

In the case of roofing membranes, the olefin resins are blended with flame retardants, usually magnesium hydroxide, UV stabilizers, colorants, and other additives. Magnesium hydroxide has a very high density and, consequently, drastically increases the weight of the membrane.

Weight considerations are important. Although, weight on a stationary building is not as critical as weight considerations on a recreational vehicle RV. Material weight on stationary buildings can have a major impact on installation. On many commercial applications and some residential applications, cranes or forklifts are required to stage materials on the roof of these applications. In many areas, especially small installations and export markets, that equipment often is not readily available.

On the synthetic rubber roofs used now, caulking may be required in order to seal the applied roof material. Since the rubber is vulcanized being used for these rubber roofs (cross-linked) cannot be heat welded or, re-heated and reshaped because of the nature of rubber. Vulcanized rubber is often referred to as thermoset material. Plastics in contrast may be referred to as thermoplastic, meaning the plastic may be re-heated and reshaped repeatedly. This characteristic of plastic allows for easy recycling of plastics and is the reason that thermoplastics should not be used as tires. The heat generated in a rolling tire could soften a thermoplastic and change the shape and characteristics of the so constructed tire.

In any event, since rubber can not be welded, all of the terminations in roofing using rubber are caulked. Caulking requires maintenance and replacement during the life of the roof because caulking may deteriorate and allow moisture to enter. In a RV application, it is recommended for the owner to inspect and repair the caulking 3 times per year. This can be burdensome for the owner.

### SUMMARY

A membrane to be used as a roofing material may include a first region having foam cavities, a second region being adjacent to the first region and a third region being adjacent to the second region having foam cavities.

The membrane may be used on a commercial building.

The membrane may be used on a vehicle.

The membrane may be used on a RV vehicle.

The membrane may have only two layers.

The membrane may have only three layers.

The membrane may have only four layers.

The membrane may have only five layers.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a single layer membrane of the present invention;

FIG. 2 illustrates a double layer membrane of the present invention;

FIG. 3 illustrates a triple layer membrane of the present invention;

FIG. 4 illustrates another triple layer membrane of the present invention;

FIG. 5 illustrates a five layer membrane of the present invention;

FIG. 6 illustrates a membrane of the present invention being applied to a vehicle;

FIG. 7 illustrates a membrane of the present invention being applied to a structure;

FIG. 8 illustrates a top view the membrane of the present invention.

### DETAILED DESCRIPTION

The present invention relates to roofing, waterproofing, geomembranes which are a kind of geosynthetic material made up of an impermeable membranes. The geomembranes may be used in lining canals, ponds and also waste containment or other construction membranes. The roofing membranes, waterproofing membranes and geomembranes which may be referred to as membrane 101 may include foaming agents or foam cavities 103 to individual layers of Thermoplastic PolyOlefin (TPO) which is a trade name that refers to polymer/filler blends and may include some fraction of PP (polypropylene), PE (polyethylene), BCPP (block copolymer polypropylene), rubber, and a reinforcing filler, PE, PP, Ethylene vinyl acetate (also known as EVA) is the copolymer of ethylene and vinyl acetate, other olefinics or Polyvinyl chloride, commonly abbreviated PVC, is a thermoplastic polymer, etc.

The present invention provides lower weight, lower modulus, and certification from the Leadership in Energy and Environmental Design (LEED) which is an internationally recognized green building certification system, providing third-party verification that a building or community was designed and built using strategies intended to improve performance in metrics such as energy savings, water efficiency, CO₂ emissions reduction, improved indoor environmental quality, and stewardship of resources and sensitivity to their impacts, improved fire test performance, improved R value (which may be a measure of thermal resistance used in the building and a difference across an insulator and the heat flux) and sound deadening. The use of foaming concentrates to form foam cavities 103, endothermic or azodicarbonamide exothermic, in one or more layers of the membrane 101 offers many improvements.

In the case of thinner gauge membranes often used in construction, the use of microcell endothermic concentrates to form foam cavities 103 which may be microcell foam cavities offers advantages over other foaming agents. The standard foam formed from conventional techniques concentrates yield bubbles sized anywhere in the range from substantially 150 to 500 microns. The Microcell bubbles 103 may be sized anywhere in the range from substantially 20-75 microns. The range can be dependent on the specific resin, machine and temperatures used. The microbubbles may be substantially 10 times smaller on average than the standard. The smaller bubbles or foam cavities 103 have less effect on physical properties of the plastic and allow higher foaming levels.

1) RV roofing
a) In a recreational vehicle (RV), foaming the bottom layer of a two layer membrane 101 can produce a significant weight savings. Most RV roofs are covered with thermoset EPDM which, due to high filler content, has a fairly high density. On an average travel trailer or Fifth wheel the EPDM portion of the roof structure will weigh approximately 54 pounds. At a level of 25% foaming in the core layer only, the membrane 101 of the present invention on the same unit will weigh 31 pounds. Obviously, higher foam levels would provide greater reduction in weight.

Considering the RV industry is forecasting building 207,500 towable units in 2011, the use of the invention industry-wide would offer a total weight savings of 4,772,500 pounds. The fuel savings in towing these units would also be significant.

b) The foam cells or foam cavities 103 of the present invention also reduce tensile and flexural modulus of the finished membrane 101 which makes the product easier to install. Stiffness has previously been an issue with thermoplastic membranes in recreational vehicles RV.
C) The foam cells or foam cavities 103 of the membrane 101 may include a degree of sound deadening when the roof is subjected to rain, hail, etc.
d) The foam cells or foam cavities 103 will also offer some improvement in insulating capability depending on the thickness of the membrane 101.

### 2) Commercial Roofing

a) Thermoplastic single-ply roofing membranes used in commercial and modular markets (except ballasted applications) contain large quantities of flame retardants to allow them to pass UL fire testing.

Along with the weight savings outlined in the RV segment, the use of foaming agents in the form of foam cavities 103 in the membrane 101 in commercial roofing offers other distinct advantages.

The membrane 101 which may include the foam cavities 103 may be included in the core layer of a coextruded membrane (which may include typically 10 mils of cap, 35 mils of core or other appropriate ratio) a 25% foam loading will reduce the amount of plastic per square foot 20%. Plastic is the fuel for any fire on the surface of the structure. The reduction of plastic lowers the fuel for a fire, resulting in a safer device. Using the endothermic concentrate to produce the foam, the foam bubbles may contain CO2 which is a fire suppressant. Membranes 101 made in this fashion will perform better in fire testing.

b) With the use of foam or foam cavities 103 in the core or inner layers, the weight savings can be significant. A typical 8 foot by 100 foot roll of commercial TPO roofing at 45 mils thick will weigh around 230 pounds. At a 40% foam level in the core layer with the present invention, the same roll would weigh 130 pounds. The foamed roll can easily be handled and loaded by 2 men. In non-US applications where flame retardants often are not required, the foamed roll of the present invention may weigh close to 100 pounds.

### 3) Geomembranes

The use of nitrogen gas may be used to roughen the exterior surfaces of geomembranes. The center layer of a 3 layer construction may be foamed or the bottom layer of a two layer construction may be foamed.

Nitrogen may be injected into the extruders feeding the top and bottom layers of a blown sheet line. Since the foaming actually takes place as the sheet exits the die and blown sheet lines do not have calender rolls, the gassing with the nitrogen essentially blows holes in the outer surface of the sheet. This rough surface allows the sheet to remain in place on the slope of a landfill. The inner layer, which is not foamed, gives the sheet structural integrity. In the present invention, the foaming concentrate is put in the center and bottom layer of a 3 layer construction, the bottom layer of a 2 layer construction or, in the case of a flat die sheet line, the foam can be place in a monolayer construction. On flat sheet lines the hot plastic runs into calender rolls which rapidly cool the sheet. This cooling effect eliminates any foaming on the surface of the sheet.

With the present invention, geomembrane constructed with the teachings of the present invention have significant weight reduction, lower use of hydrocarbon materials and less power required to manufacture the geomembrane product.

The present invention provides construction membranes that have the following advantages: lower weight, higher R value, sound deadening capability, better fire test performance, LEED certification capability, reduced power requirements, and reduced freight costs.

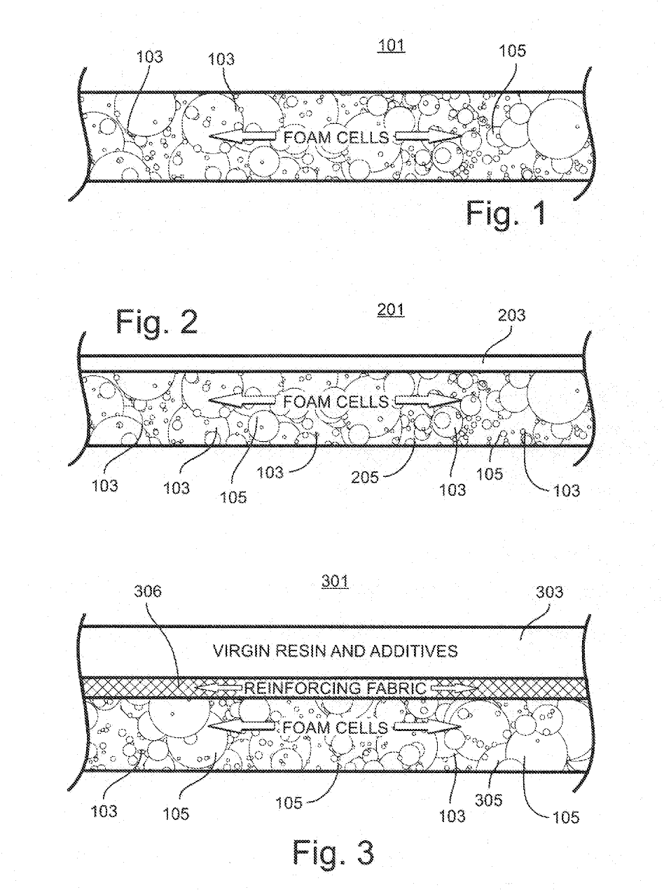

FIG. 1 illustrates a cross-sectional view the membrane 101 which may be a single layer and which may be formed from plastic resin or other material as described above and which may include a first region 105 which may include a multiple foam cavities 103 which may have been formed during the formation of the membrane 101 by an internal foaming action. The first region 105 which may include a multiple foam cavities 103 which may be formed during the formation of the membrane 101 by internal foaming action.

FIG. 2 illustrates a cross-sectional view the membrane 201 which may be a double layer. The membrane 201 may include a first layer 203 which may be formed from a virgin resin and may include additives and may include a second layer 205 which may be formed from plastic resin or other material as described above and which may include a first region 105 which may include a multiple of foam cavities 103 which may have been formed during the formation of the membrane 201 by an internal foaming action. The first region 105 may include a multiple of foam cavities 103 which may be formed during the formation of the membrane 201 by internal foaming action. Alternatively, the first layer 203 may be substantially free from foam cavities 103 or may include foam cavities 103.

FIG. 3 illustrates a cross-sectional view the membrane 301 which may be a triple layer. The membrane 301 may include a first layer 303 which may be formed from a virgin resin and may include additives, may include a third layer 306 which may include a reinforcing fabric sandwiched between the outer first layer 303 and the outer second layer 305 and may include a second layer 305 which may be formed from plastic resin or other material as described above and which may include a first region 105 which may include a multiple foam cavities 103 which may have been formed during the formation of the membrane 301 by an internal foaming action. The first region 105 may include a multiple of foam cavities 103 which may be formed during the formation of the membrane 201 by internal foaming action. Alternatively, the first layer 303 may be substantially free from foam cavities 103 or may include foam cavities 103.

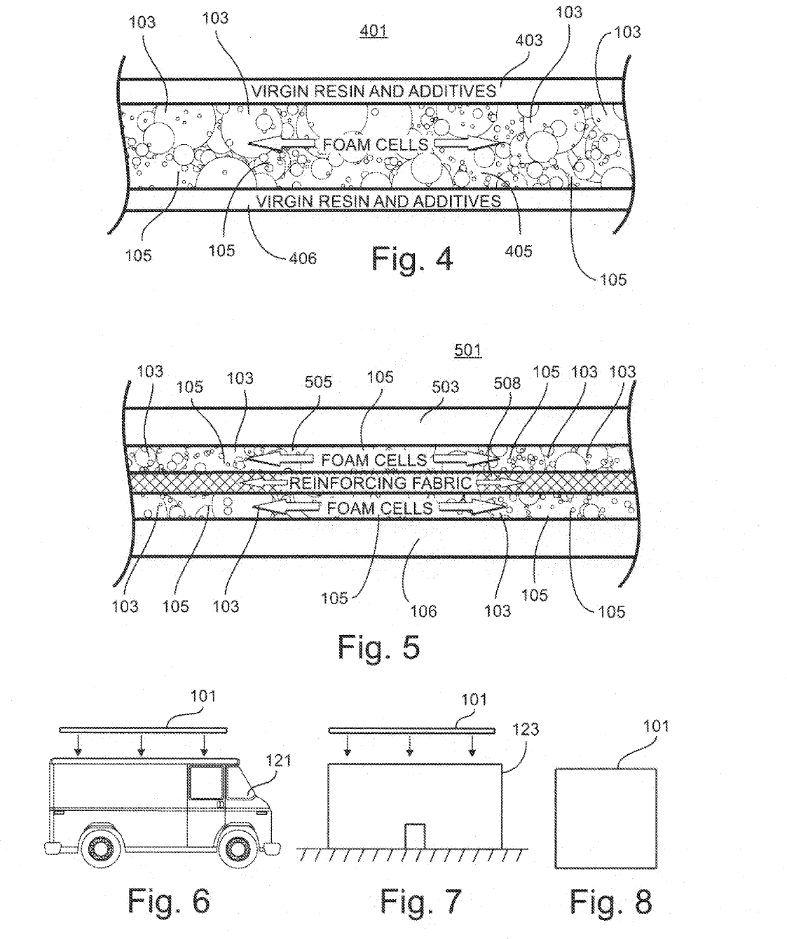

FIG. 4 illustrates a cross-sectional view the membrane 401 which may be a triple layer. The membrane 401 may include a first outer layer 403 which may be formed from a virgin resin and may include additives, may include a third outer layer 406 which may be formed from a virgin resin and may include additives and may include a second layer 405 which may be sandwiched between the first outer layer 403 and the third outer layer 406 and which may be formed from plastic resin or other material as described above and which may include a first region 105 which may include a multiple foam cavities 103 which may have been formed during the formation of the membrane 301 by an internal foaming action. The first region 105 may include a multiple of foam cavities 103 which may be formed during the formation of the membrane 401 by internal foaming action. Alternatively, the first layer 403 and the third layer 406 may be substantially free from foam cavities 103 or may include foam cavities 103.

FIG. 5 illustrates a cross-sectional view the membrane 501 which may be five layer's. The membrane 501 may include a first outer layer 503 which may be formed from a virgin resin and may include additives, may include a fifth outer layer 506 which may be formed from a virgin resin and may include additives and may include a second layer 505 and a third layer 504 which may be a substantial mirror of the second layer 505 and which may be sandwiched between the first outer layer 503 and the fifth outer layer 506 and which may be formed from plastic resin or other material as described above and which may include a first region 105 which may include a multiple foam cavities 103 which may have been formed during the formation of the membrane 301 by an internal foaming action. The first region 105 may include a multiple of foam cavities 103 which may be formed during the formation of the membrane 401 by internal foaming action. Alternatively, the first layer 503 and the fifth layer 506 may be substantially free from foam cavities 103 or may include foam cavities 103. The membrane 501 may include a center fourth layer 508 which may include a fabric reinforcement.

FIG. 6 illustrates a vehicle 121 with a membrane 101, 201, 301, 401, 501 positioned on the vehicle.

FIG. 7 illustrates a building 123 with a membrane 101, 201, 301, 401, 501 positioned on the building 123.

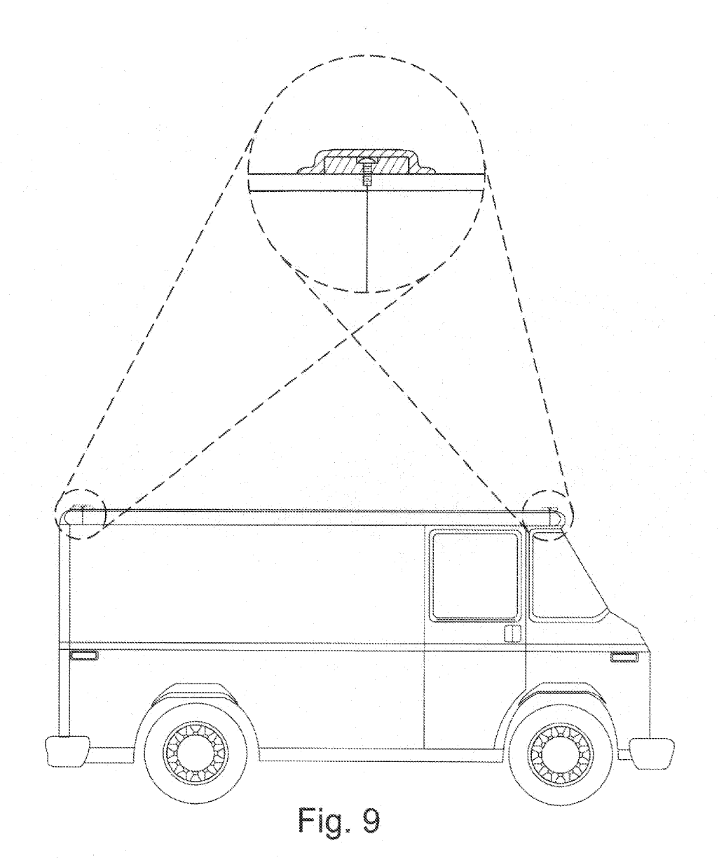

FIG. 8 illustrates a top view of the membrane 101, 201, 301, 401, 501. One method of forming the membranes of the present invention is to employ an extrusion line, the resin and foaming concentrate is fed into what is essentially a pipe which may be 6 inches in diameter that includes a rotating screw or auger to advance the concentrate.

The pipe extends into what is referred to as a coathanger die since that is what the internal design looks like. Basically a big clam shell shaped device that has an entry port in the back. The plastic concentrate flows into the clam shell shaped device and spreads out due to the increased volume. The foam concentrate, being part of the resin mix, follows the plastic flow and you have foam formed in the space wherever the resin is.

The amount of foam is controlled by the amount of concentrate and the temperature. Controlling how many layers of bubbles may be formed or to include voice voids that do not contain bubbles may be problematic.

In response to the above noted caulking problem a modified hot melt adhesive may be used for essentially replacing the caulking with the hot melt adhesive. Since the hot melt is applied at a temperature above the melting point of the membrane, it essentially fuses itself to the membrane. The hot melt may be made from a resin similar to the membrane and has a UV package in it so it reduces the maintenance requirements.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A membrane to be used as a roofing material, comprising:
a first region having foam cavities;
a second region being adjacent to the first region;
a third region being adjacent to the second region having foam cavities;

2) A membrane to be used as a roofing material as in claim 1, wherein the membrane is used on a commercial building.

3) A membrane to be used as a roofing material as in claim 1, wherein the membrane is used on a vehicle.

4) A membrane to be used as a roofing material as in claim 3, wherein the membrane is used on a RV vehicle.

5) A membrane to be used as a roofing material as in claim 1, wherein the membrane has only two layers.

6) A membrane to be used as a roofing material as in claim 1, wherein the membrane has only three layers.

7) A membrane to be used as a roofing material as in claim 1, wherein the membrane has only four layers.

8) A membrane to be used as a roofing material as in claim 1, wherein the membrane has only five layers.
